(19) United States
(12) Patent Application Publication
(10) Pub. No.: US 2016/0070343 A1
(43) Pub. Date: Mar. 10, 2016

(54) INFORMATION PROCESSING METHOD AND ELECTRONIC DEVICE

(71) Applicants: BEIJING LENOVO SOFTWARE LTD., Beijing (CN); LENOVO (BEIJING) LIMITED, Beijing (CN)

(72) Inventor: Ligang LI, Beijing (CN)

(73) Assignees: BEIJING LENOVO SOFTWARE LTD., Beijing (CN); LENOVO (BEIJING) LIMITED, Beijing (CN)

(21) Appl. No.: 14/618,384

(22) Filed: Feb. 10, 2015

(30) Foreign Application Priority Data
Sep. 9, 2014 (CN) 201410456690.1
Sep. 15, 2014 (CN) 201410468803.X

(51) Int. Cl. G06F 3/01; G02B 27/01; G06T 11/60; G06T 19/00

(52) U.S. Cl. CPC G06F 3/012; G06T 19/006; G02B 27/0172; G06T 11/60

(57) ABSTRACT

An information processing method is disclosed. The method comprises determining whether a head-mounted electronic device has changed from a first position to a second position, wherein the head-mounted electronic device comprises an image capture unit and a display unit for displaying a virtual scene; and capturing an image of an environment where a user of the head-mounted electronic device is located by using the image capture unit of the head-mounted electronic device and displaying the image, or a part thereof, via the display unit of the head-mounted electronic device for viewing by the user. Also disclosed is an information processing method and an electronic device. The method comprises: obtaining environment information about a real-world environment where a display is located with the sensor and generating security warning information based on the environment information; and presenting, via the display, a virtual scene independent from the real-world environment along with the security warning information.

### TECHNICAL FIELD

The present application relates to electronic information technology, and more particularly, to an information processing method and an electronic device.

### BACKGROUND

With the development of science and technology and the rapid growth of electronic product market, various portable electronic devices, such as tablet computers, smart phones and portable multi-media players, have been widely used. However, when a user is using a conventional portable electronic device, he/she needs to hold it with his/her hands and maintain a particular position so as to operate the electronic device or view contents displayed on the electronic device. Thus, it is difficult for the user to make other motions when operating the electronic device. In addition, the user will easily get tired after maintaining the particular position for a long time.

In order to improve the user experience, wearable electronic devices having communication and audio/video playing functions, for example, have been developed. Among these devices, head-mounted electronic devices become particularly attractive for their multi-functionality and enhanced user experience. However, when a user wants to perform other operations, e.g., checking his/her companion's status or viewing his/her cell phone, while he/she is using a head-mounted electronic device to view a video for example, since the head-mounted electronic device he/she is wearing covers his/her eyes, he/she needs to take off the head-mounted electronic device before he/she can view the real-world environment. Since the user cannot obtain information on the real-world environment directly through the head-mounted electronic device, it is very convenient for him/her to perform other operations.

In addition, with various digital techniques for information retrieving, storing and computing, a vivid virtual scene can be created in an electronic device, where a user can overcome spatial, temporal and other objective limitations to experience what he/she cannot experience in the real world. Currently, a display device can present to a user a virtual scene distinct from the real-world environment and allow the user to interact with the virtual scene by using dedicated input/output devices. For example, when a user is wearing a head-mounted display and a pair of ski-boots with sensors, the head-mounted display can display pictures where mountains, valleys and cliffs covered in white pass by in response to motion data acquired by the sensors, such that the user can feel as if he/she is skiing in the real world. However, when the user is using such display device, there may be a case where the virtual scene environment is very different from the real-world environment, particularly when a completely virtualized scene is displayed. In this case, since the user cannot view the real-world environment, he/she may have an accident when acting in accordance with the virtual scene environment.

### SUMMARY

In an embodiment of the present application, an information processing method is provided. The method comprises: determining whether a head-mounted electronic device has changed from a first position to a second position, wherein the head-mounted electronic device comprises an image capture unit and a display unit for displaying a virtual scene; and capturing an image of an environment where a user of the head-mounted electronic device is located by using the image capture unit of the head-mounted electronic device and displaying the image, or a part thereof, via the display unit of the head-mounted electronic device for viewing by the user.

Optionally, the step of determining whether the head-mounted electronic device has changed from the first position to the second position comprises: determining whether an angle between the head-mounted electronic device and a horizontal plane has changed from a first angle to a second angle.

Optionally, the method further comprises determining whether the second position satisfies a predetermined condition, which comprises: determining whether a difference between the first angle and the second angle lies within a predetermined angle range.

Optionally, the step of determining whether the head-mounted electronic device has changed from the first position to the second position comprises: determining whether a distance between a gravity center of the head-mounted electronic device and a predetermined reference point has changed from a first distance to a second distance.

Optionally, the method further comprises determining whether the second position satisfies a predetermined condition, which comprises: determining whether a difference between the first distance and the second distance lies within a predetermined distance range.

Optionally, the step of determining whether the head-mounted electronic device has changed from the first position to the second position comprises: determining whether a direction the display unit faces has changed from a first direction to a second direction.

Optionally, the method further comprises determining whether the second position satisfies the predetermined condition, which comprises: determining whether an angle between the first direction and the second direction is larger than a predetermined angle threshold.

In a further embodiment of the present application, a head-mounted electronic device is provided. The head-mounted electronic device comprises an image capture unit, and a display unit for displaying a virtual scene. The head-mounted electronic device further comprises: a first determining unit configured to determine whether the head-mounted electronic device has changed from a first position to a second position; and a processing unit configured to capture an image of an environment where a user of the head-mounted electronic device is located by using the image capture unit and display the image, or a part thereof, via the display unit for viewing by the user.

Optionally, the first determining unit is configured to: determine whether an angle between the head-mounted electronic device and a horizontal plane has changed from a first angle to a second angle.

Optionally, the electronic device further comprises a second determining unit configured to: determine whether a difference between the first angle and the second angle lies within a predetermined angle range.

Optionally, the first determining unit is configured to: determine whether a distance between a gravity center of the head-mounted electronic device and a predetermined reference point has changed from a first distance to a second distance.

Optionally, the electronic device further comprises a second determining unit configured to: determine whether a difference between the first distance and the second distance lies within a predetermined distance range.

Optionally, the first determining unit is configured to: determine whether a direction the display unit faces has changed from a first direction to a second direction.

Optionally, the electronic device further comprises a second determining unit configured to: determine whether an angle between the first direction and the second direction is larger than a predetermined angle threshold.

In a further embodiment of the present application, an information processing method is provided. The method is applied in an electronic device comprising a display and a sensor. The method comprises: obtaining environment information about a real-world environment where the display is located with the sensor and generating security warning information based on the environment information; and presenting, via the display, a virtual scene independent from the real-world environment along with the security warning information.

Optionally, the security warning information contains obstacle information and traffic condition information.

Optionally, the step of presenting the virtual scene independent from the real-world environment along with the security warning information comprises: detecting, while presenting the virtual scene, a current distance between the user and an obstacle associated with the obstacle information contained in the security warning information; determining whether the current distance is shorter than a predetermined distance; and displaying the security warning information in the virtual scene if the current distance is shorter than the predetermined distance.

Optionally, the security warning information contains an image of the real-world environment and the step of presenting the virtual scene independent from the real-world environment along with the security warning information comprises: detecting, while presenting the virtual scene, a current distance between the user and an obstacle associated with the obstacle information contained in the security warning information; and displaying the image of the real-world environment instead of the virtual scene if the current distance is shorter than a predetermined distance.

Optionally, the security warning information comprises at least one of: obstacle image information for identifying an obstacle in the real-world environment that is associated with the obstacle information; text information for identifying a distance between the obstacle and a landmark in the virtual scene; image representation information for identifying a traffic condition in the real-world environment; and identification information for identifying a secure area for activities in the real-world environment.

In a further embodiment of the present application, an electronic device is provided. The electronic device comprises a display; a sensor; an information processing unit configured to obtain environment information about a real-world environment where the display is located by using the sensor and generate security warning information based on the environment information; and a display control unit configured to present, via the display, a virtual scene independent from the real-world environment along with the security warning information.

Optionally, the security warning information contains obstacle information and traffic condition information.

Optionally, the display control unit comprises: a detecting subunit configured to detect, while presenting the virtual scene, a current distance between the user and an obstacle associated with the obstacle information contained in the security warning information; a determining subunit configured to determine whether the current distance is shorter than a predetermined distance; and a control subunit configured to display the security warning information in the virtual scene if the current distance is shorter than the predetermined distance.

Optionally, the display control unit comprises: a detecting subunit configured to detect, while presenting the virtual scene, a current distance between the user and an obstacle associated with the obstacle information contained in the security warning information; and a control subunit configured to display an image of the real-world environment instead of the virtual scene if the current distance is shorter than a predetermined distance.

Optionally, the security warning information comprises at least one of: obstacle image information for identifying an obstacle in the real-world environment that is associated with the obstacle information; text information for identifying a distance between the obstacle and a landmark in the virtual scene; image representation information for identifying a traffic condition in the real-world environment; and identification information for identifying a secure area for activities in the real-world environment.

With the embodiments of the present application, when it is determined that the head-mounted electronic device has changed from a first position to a second position and that the second position satisfies a predetermined condition, an image of the real-world environment where a user of the head-mounted electronic device is located is captured with the image capture unit and the image, or a part thereof, is displayed on the display unit, such that the user can view the environment via the head-mounted electronic device. Thus, the user can view the image on the display unit by simply changing the position of the head-mounted electronic device. Further, since the user uses the head-mounted electronic device while wearing it, he/she can view the real-world environment by simply changing his/her position, without having to take off the head-mounted electronic device. Hence, the user can perform other operations as desired more conveniently, which provides an enhanced user experience. Moreover, the display function of the head-mounted electronic device can be improved and thus the operability and applicability of the head-mounted electronic device can be enhanced.

With the embodiments of the present application, the electronic device obtains environment information about a real-world environment where the display is located and generates security warning information based on the environment information, so as to present a virtual scene along with the security warning information associated with the real-world environment, thereby providing the user with a security warning and improving the security in using the display. While presenting the virtual scene, the electronic device automatically selects a current distance between the user and an obstacle and determines whether the current distance is shorter than a predetermined distance. Upon determining that the current distance is shorter than the predetermined distance, the electronic device displays in the virtual scene an image of the obstacle in the real-world environment or a distance between the obstacle and a landmark, thereby prompting the user to bypass the obstacle without having to switch to the real-world environment. In this way, the continuity in displaying the virtual scene can be guaranteed and the user experience can be improved.

### BRIEF DESCRIPTION OF THE DRAWINGS

In order to illustrate the solutions according to the embodiments of the present application or the prior art in further detail, the figures used for description of the embodiments or the prior art will be introduced briefly here. It is apparent to those skilled in the art that the figures described below only illustrate some embodiments of the present application and other figures can be obtained from these figures without applying any inventive skills.

FIG. 1 is a flowchart illustrating an information processing method according to an embodiment of the present application;

FIG. 2 is a schematic diagram showing a scenario in which a direction a display unit of a head-mounted electronic device faces changes from a first direction to a second direction according to an embodiment of the present application;

FIG. 3 is a schematic diagram showing a scenario in which a first display content is displayed in a first display area of the display unit and an image is displayed in the second display area of the display unit according to an embodiment of the present application;

FIG. 4 is a block diagram of a head-mounted electronic device according to an embodiment of the present application;

FIG. 5 is a flowchart illustrating an information processing method according to a first embodiment of the present application;

FIG. 6 is a schematic diagram showing security warning information according to a first embodiment of the present application; and

FIG. 7 is a block diagram of an electronic device according to a second embodiment of the present application.

### DETAILED DESCRIPTION OF THE EMBODIMENTS

According to an embodiment of the present application, an information processing method can be applied in a head-mounted electronic device. The method includes: determining whether the head-mounted electronic device has changed from the first position to a second position, wherein the head-mounted electronic device comprises an image capture unit and a display unit for displaying a virtual scene; and capturing an image of an environment where a user of the head-mounted electronic device is located by using the image capture unit of the head-mounted electronic device and displaying the image, or a part thereof, via the display unit of the head-mounted electronic device for viewing by the user.

According to an embodiment of the present application, environment information about a real-world environment where a display is located is obtained and security warning information is generated based on the environment information, so as to present a virtual scene along with the security warning information, thereby providing the user with a security warning. In this way, the technical problem associated with low security in use of the display can be solved and the security in use of the display can be improved.

In the following, the solutions according to the embodiments of the present application will be described clearly and fully with reference to the figures. Obviously, the embodiments described below are only some, rather than all, of the embodiments. Starting from the embodiments of the present application, those skilled in the art can obtain other embodiments with applying any inventive skills. All these embodiments are to be encompassed by the scope of the present application. The embodiments of the present application, and the features thereof, can be combined with each other as appropriate. Further, while a logic sequence is shown in the flowchart, in some cases the steps shown or described herein can be performed in a different sequence.

Further, the term “and/or” as used herein only represents a relationship between correlated objects, including three possibilities. For example, “A and/or B” means A, B, or both. In addition, unless indicated otherwise, the symbol “/” as used herein represents an “or” relationship between the correlated objects preceding and succeeding the symbol.

The solutions of the present application will be detailed in the following with reference to the figures and embodiments, such that they can be better understood.

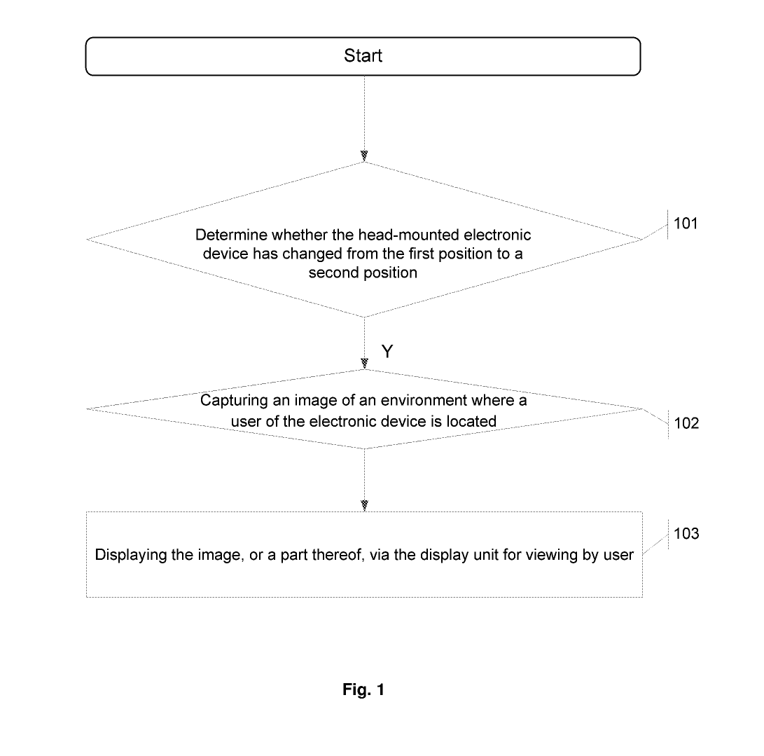

Referring to FIG. 1, according to an embodiment of the present application, an information processing method is provided. The method can be applied in a head-mounted electronic device. The primary process flow of the method will be described as follows.

At step 101, it is determined whether the head-mounted electronic device has changed from a first position to a second position. The display unit displays a first display content, which is a display content for a virtual scene, when the head-mounted electronic device has the first position.

In an embodiment of the present application, the head-mounted electronic device may be shaped like a helmet or glasses, or may have any of other shapes. The present application is not limited to any specific shape and style of the head-mounted electronic device.

The head-mounted electronic device has a display unit and an image capture unit.

The display unit can be a display screen, i.e., an Organic Light-Emitting Diode (OLED) display screen, a Liquid Crystal Display (LCD) screen or the like. A user wearing the head-mounted electronic device can view images or videos via the display unit.

The image capture unit can be a camera unit, e.g., a conventional camera, an infrared camera, or the like. With the image capture unit, the head-mounted electronic device can obtain an image associated with the real-world environment surrounding the head-mounted electronic device, such that the image can be displayed on the display unit under the control the of the head-mounted electronic device. In addition, the embodiment of the present application is not limited to any specific forms and materials of the display unit and the image capture unit.

The head-mounted electronic device may have various positions. In the embodiment of the present application, whether a change in the position of the head-mounted electronic device satisfies a predetermined condition is used as a trigger condition whether the display unit is to display the image or not.

In the embodiment of the present application, the display unit displays the first display content when the head-mounted electronic device has the first position. In particular, the first display content is a display content for a virtual scene, e.g., a picture in a movie the user is watching or a picture in a game the user is playing.

When the head-mounted electronic device has the first position, it can automatically determine whether its current position has changed from the first position to the second position. There are various schemes for determining whether the head-mounted electronic device has changed from the first position to the second position. Three of them will be described below as examples.

First Determination Scheme

Optionally, the step of determining whether the head-mounted electronic device has changed from the first position to the second position comprises: determining whether an angle between the head-mounted electronic device and a horizontal plane has changed from a first angle to a second angle.

In the embodiment of the present application, it is determined whether the position of the head-mounted electronic device has changed by determining whether the angle between the head-mounted electronic device and the horizontal plane has changed. Here, the horizontal plane means a plane that is formed by complete stationary water or any plane parallel thereto. When the head-mounted electronic device has the first position, the angle between it and the horizontal plane is the first angle. When the head-mounted electronic device detects that the angle between it and the horizontal plane has changed from the first angle to the second angle with a sensor, it determines that its position has changed from the first position to the second position. Here, when the head-mounted electronic device has the second position, the angle between it and the horizontal plane is the second angle.

The head-mounted electronic device can detect the angle between it and the horizontal plane with a sensor which can be for example a gyro, an acceleration sensor or a gravity sensor.

Second Determination Scheme

Optionally, the step of determining whether the head-mounted electronic device has changed from the first position to the second position comprises: determining whether a distance between a gravity center of the head-mounted electronic device and a predetermined reference point has changed from a first distance to a second distance.

In the embodiment of the present application, it is determined whether the position of the head-mounted electronic device has changed by determining whether the distance between the gravity center of the head-mounted electronic device and the predetermined reference point has changed. For example, the distance can be detected by a sensor in a head-mounted electronic device, which can be for example a gyro, an acceleration sensor or a gravity sensor. Here, the predetermined reference point can be any fixed point in the space where the head-mounted electronic device is located. The distance refers to the straight-line distance between the gravity center and the predetermined reference point. When the head-mounted electronic device has the first position, the distance between the gravity center and the predetermined reference point is the first distance. When it is detected that the distance between the gravity center and the predetermined reference point has changed from the first distance to the second distance, it is determined that the position of the head-mounted electronic device has changed from the first position to the second position. When the head-mounted electronic device has the second position, the distance between the gravity center and the predetermined reference point is the second distance.

Third Determination Scheme

Optionally, the step of determining whether the head-mounted electronic device has changed from the first position to the second position comprises: determining, whether a direction the display unit faces has changed from a first direction to a second direction.

In the embodiment of the present application, it is determined whether the position of the head-mounted electronic device has changed by determining whether the direction the display unit in the head-mounted electronic device faces has changed. When the head-mounted electronic device is located in a fixed position, the display unit fixed in the head-mounted electronic device is also located in a fixed position. In this case, the direction the display unit faces is a fixed direction. For example, when the head-mounted electronic device has the first position, the direction the display unit faces is the first direction. A sensor in the head-mounted electronic device can determine whether the direction the display unit faces has changed. When it is determined that the direction the display unit faces has changed from the first direction to the second direction, it is determined that the position of the head-mounted electronic device has changed from the first position to the second position. When the head-mounted electronic device has the second position, the direction the display unit faces is the second direction.

In the embodiment of the present application, all of the above three schemes for determining whether the head-mounted electronic device has changed from the first position to the second position are carried out by the head-mounted electronic device automatically. From the change in the position of the head-mounted electronic device, the change in the position of the user who is using the head-mounted electronic device can be determined since the head-mounted electronic device is worn by the user on his/her head. Hence, the position of the head-mounted electronic device changes as the user's position changes. The head-mounted electronic device can detect the change in the user's position in real time, so as to determine the user's requirements. A number of determination schemes have been provided in the present application. In practice, different schemes can be selected as desired, which is quite flexible.

It is to be noted here that the present application is not limited to the above three determination schemes. All the schemes that can determine whether the position of the head-mounted electronic device has changed are encompassed in the scope of the present application.

Preferably, it is determined whether the second position satisfies a predetermined condition.

In the embodiment of the present application, when determining that the head-mounted electronic device has changed from the first position to the second position, the head-mounted electronic device proceeds with determining whether the second position satisfies the predetermined condition.

In implementation, there can be various predetermined conditions. In the embodiment of the present application, three predetermined conditions corresponding to the above three schemes for determining whether the head-mounted electronic device has changed from the first position to the second position, respectively, will be explained as example for facilitating readers' understanding.

First Predetermined Condition

Optionally, the step of determining whether the second position satisfies the predetermined condition comprises: determining whether a difference between the first angle and the second angle lies within a predetermined angle range.

The first predetermined condition provided in this embodiment corresponds to the above first determination scheme. In this case, the predetermined condition can be that the difference between the first angle and the second angle lies within the predetermined angle range.

When it is determined that the angle between the head-mounted electronic device and the horizontal plane has changed from the first angle to the second angle, it needs to determine whether the difference between the first angle and the second angle lies within the predetermined angle range. For example, the predetermined angle range can be [45°, 160°]. When the user wearing the head-mounted electronic device sits up straight, it is detected that the angle between the head-mounted electronic device and the horizontal plane, i.e., the first angle, is 90°. When the user tilts his/her head to the left, it is detected that the angle between the head-mounted electronic device and the horizontal plane has changed from the first angle to the second angle, which is e.g., 140°. In this case, the difference between the first and second angles is 50°, which lies within the predetermined angle range. Then, the second position associated with the second angel satisfies the predetermined condition.

Further, when the user is using the head-mounted electronic device while maintaining a single position for a long time, he/she may tilt his/her head slightly to the left or right unintentionally. In order to avoid considering such slight motion of the user as satisfying the predetermined condition, the predetermined angle range can be set as desired in an embodiment of the present application.

Second Predetermined Condition

Optionally, the step of determining whether the second position satisfies the predetermined condition comprises: determining whether a difference between the first distance and the second distance lies within a predetermined distance range.

The second predetermined condition provided in this embodiment corresponds to the above second determination scheme. In this case, the predetermined condition can be that the difference between the first distance and the second distance lies within the predetermined distance range.

When it is determined that the distance between the gravity center of the head-mounted electronic device and the predetermined reference point has changed from the first distance to the second distance, it needs to determine whether the difference between the first distance and the second distance lies within the predetermined distance range, which can be dependent on the setting of the predetermined reference point.

For example, the position of the user's feet can be set as the predetermined reference point and the predetermined distance range can be [0.1 m, 0.4 m]. When the user is sitting, wearing the head-mounted electronic device to watch a movie, the first distance is 1.45 m. When the user shakes his/her body significantly, the second distance is e.g., 1.58 m. Alternatively, when the user stands up, the second distance is e.g., 1.75 m. It can be seen that the differences between 1.58 m and 1.75 m and the first distance 1.45 m are 0.13 m and 0.3 m, respectively, both of which lie within the predetermined distance range. Then, the second positions associated with 1.58 m and 1.75 m both satisfy the predetermined condition.

Third Predetermined Condition

Optionally, the step of determining whether the second position satisfies the predetermined condition comprises: determining whether an angle between the first direction and the second direction is larger than a predetermined angle threshold.

The third predetermined condition provided in this embodiment corresponds to the above third determination scheme. In this case, the predetermined condition can be that the angle between the first direction and the second direction is larger than the predetermined angle threshold.

When it is determined that the direction the display unit of the head-mounted electronic device faces has changed from the first direction to the second direction, it needs to determine whether the angle between the first direction and the second direction is larger than the predetermined angle threshold.

When the angle between the first direction and the second direction is large, it indicates that the user's head moves significantly. It is likely that the user wants to change the display content at this time. This determination condition is added as sometimes the user moves his/her head simply because he/she wants to move slightly, in which case his/her head may move slightly. Without this determination condition, the head-mounted electronic device may change the display content in this case, which will cause inconvenience for the user. Hence, with the addition of this determination condition, the erroneous response rate of the head-mounted electronic device can be effectively reduced.

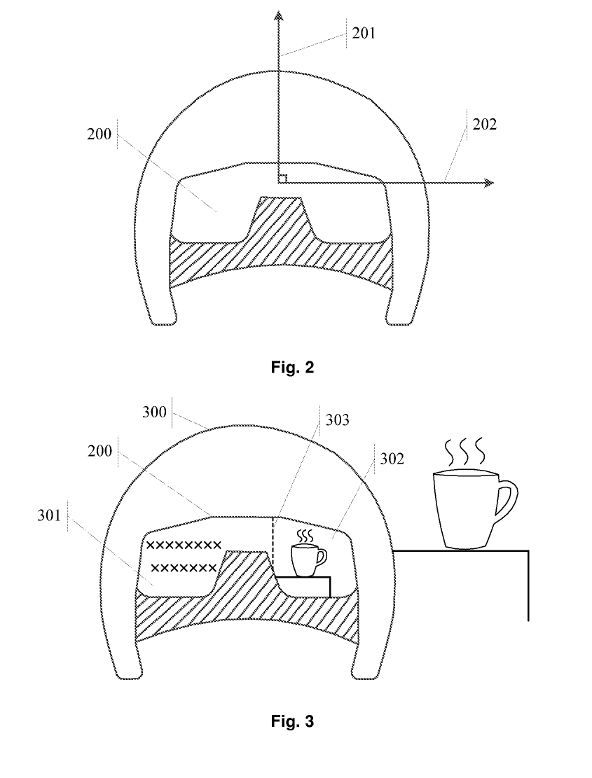

Referring to FIG. 2, when the head-mounted electronic device has the first position, the direction the display unit 200 faces is the first direction 201. When the direction the display unit 200 faces has changed from the first direction 201 to the second direction 202, the angle between the first direction 201 and the second direction 202 is detected. In an example, the angle is 90° in FIG. 2. In this case, when the direction the display unit 200 faces is the first direction 201, the user faces straight ahead. When the direction the display unit 200 faces is the second direction 202, the user faces his/her right shoulder, i.e., he/she turns his/her head to the right by 90°. Thus, the angle between the first direction 201 and the second direction 202 is 90°. In an embodiment where the predetermined angle threshold is set to 70°, it can be determined that the second position associated with the second direction 202 satisfies the predetermined condition since 90° is larger than 70°.

Of course, the specific parameters in the above three predetermined conditions can be set depending on actual situations. Further, in order to ensure the accuracy of the determination for the second position, more than one or all of the above three determination schemes can be considered jointly to determine whether the second position satisfies the predetermined condition.

It is to be noted here that only three predetermined conditions for determination for the second position have been described above. Details of other possible predetermined conditions will be omitted here. All the predetermined schemes for determination for the second position are to be encompassed by the scope of the present application.

In the embodiment of the present application, various predetermined conditions can be set freely as desired. Further, the head-mounted electronic device can automatically determine whether the second position satisfies the predetermined condition and in turn determine the actual requirement of the user based on the determination result, thereby improving the intelligence and applicability of the head-mounted electronic device.

At step 102, an image of an environment where a user of the head-mounted electronic device is located is captured by using the image capture unit of the head-mounted electronic device. At step 103, the image, or a part thereof, is displayed via the display unit of the head-mounted electronic device for viewing by the user.

In the embodiment of the present application, for example, a user is wearing the head-mounted electronic device to watch a movie, enjoying a display effect achieved by the head-mounted electronic device that is superior to that can be achieved by a conventional display and closer to the real-world scene. At this time, in an event where the user wants to perform an operation that he/she can perform only when he/she sees the real-world environment, e.g., when the user feels thirsty and wants to drink water, when the user feels the vibration of his/her cell phone in his/her pocket and wants to check the status of the cell phone, or when the user wants to check the status of his/her friend sitting beside him/her, he/she can simply make a motion, e.g., turning his/her head or shaking his/her body. The head-mounted electronic device can detect the user's motion and in turn determine whether the second position the head-mounted electronic device has after the user's motion satisfies the predetermined condition. When the second position satisfies the predetermined condition, the head-mounted electronic device initiates the image capture unit to capture an image of a real-world environment where a user is located and displays the image, or a part thereof, on the display unit. In this way, the user can view the real-world environment directly via the display unit, without having to take off or turn off the head-mounted electronic device, such that he/she can conveniently take a cup for drinking water, check the status of his/her cell phone, or check his/her friend's status while watching a movie.

In the embodiment of the present application, in response to the user's motion, the head-mounted electronic device can automatically determine whether the head-mounted electronic device has changed from the first position to the second position by utilizing one or more of the above determination schemes and, when determining that the second position satisfies the predetermined condition, capture and display the image associated with the real-world environment. That is, it is possible to detect the user's operation and in turn determine the user's requirement without any manual operation of the user, such that the user experience can be improved and the intelligence and applicability of the head-mounted electronic device can be enhanced.

Further, an image of a real-world environment where a user is located can be captured by using the image capture unit and the image, or a part thereof, can be displayed via the display unit. In this way, the user can view the image associated with the real-world environment directly via the display unit, without having to take off or turn off the head-mounted electronic device, such that he/she can conveniently perform another operation. Thus, the operation in which the user takes off or turns off the head-mounted electronic device can be saved, such that the user can view the display content for the real-world environment while viewing the display content for the virtual scene on the display unit. In this way, the display function of the head-mounted electronic device can be improved and the market competitiveness of the head-mounted electronic device can be enhanced.

Optionally, in an implementation of the embodiment of the present application, the step 103 where the image, or a part thereof, is displayed via the display unit for viewing by the user may include the following situations.

First Situation

The head-mounted electronic device controls the display unit to stop displaying the first display content and to display the image, or a part thereof.

In the first situation, when the head-mounted electronic device determines that the second position satisfies the predetermined condition and captures the image, it controls the display unit to stop displaying the first display content and to display the image alone on the display unit. In the first situation, the display content on the display unit facilitates some important operation of the user, e.g., dialing back an important call or sending an important message. In this case, considering the important operation to be performed by the user, temporarily stopping viewing the first display content will not affect the user's use and mood. Instead, it facilitates the user's timely operation.

Second Situation

The head-mounted electronic device controls the display unit to display the first display content and the image alternately at a predetermined frequency.

For example, when the first display content the user is viewing and the operation the user wants to perform are both unimportant to the user, the display unit can adopt the display scheme in the second situation, i.e., to display the first display content and the image alternately on the display unit at the predetermined frequency. The predetermined frequency can be set depending on the actual situation. In this case, the user can view the environment where he/she is located while watching the overview of the first display content.

Third Situation

The display area of the display unit is divided into a first display area and a second display area. The head-mounted electronic device controls the first display area to display the first display content or a part thereof, and controls the second display area to display the image or a part of thereof.

For example, when the user considers the first display content to be important or interesting and the operation the user needs to perform is also important but takes a short time, the display scheme of the display unit in the third situation can be adopted.

In the following, the display scheme in the third situation will be explained with reference to a specific example where the head-mounted electronic device is shaped like a helmet.

Referring to FIG. 3, the display unit 200 of the head-mounted electronic device 300 can be divided into a first display area 301 and a second display area 302. Here the first display area 301 and the second display area 302 are separated via a separating line 303 on the display unit 200. In an implementation, the separating line 303 does not physically exist. That is, the surface of the display unit 200 is smooth and flat. Hence, the separating line 303 is indicated as a dashed line in FIG. 3.

When the movie the user is watching on the display unit 200 has its story reversed, the user is too excited and wants to drink coffee for calming down. However, the coffee is too hot and the user needs to view the coffee cup clearly to prevent him/her from being scalded. In this case, the head-mounted electronic device 300 can control the first display area 301 to continue playing the movie, i.e., continue displaying the first display content, and control the second display area 302 to display the image. As shown in FIG. 3, the movie content the user is watching is displayed on the first display area 301 and the desk in front of the user and the coffee cup on the table are displayed on the second display area 302. The user can view the change in the story of the movie on the first display area 301, while taking the coffee cup accurately based on the display content on the second display area 302. In this way, the user can perform the operation accurately while watching the movie, so as to avoid adverse consequences, such as scalds, due to erroneous operations such as knocking over the coffee cup.

Of course, when the first display content and the image are being displayed at the same time, since the display unit 200 is divided into the first display area 301 and the second display area 302, the areas for displaying the first display content and the image on the display unit 200 will be reduced. In an implementation, the display areas of the first display area 301 and the second display area 302 can be set depending on the user's requirement or can be manually adjusted by the user. Generally, the user mainly views the first display content. In this case, the area of the first display area 301 can be set to be larger than the area of the second display area 302.

Further, when the image capture unit captures images of all other viewers watching the movie surrounding the user but actually the user only wants to view the status of his/her friend closest to him/her. Alternatively, due to the limitation on the display area, if the entire image is displayed, the displayed image will be very small, which affects the user's view. In this case, when the second display area 302 is controlled to display the image, it can only display a part of the image. For example, only the clearest part of the image that shows the part closest to the user can be displayed.

In the embodiment of the present application, the display unit 200 is divided into the first display area 301 and the second display area 302. The first display area 301 is controlled to display the first display content and the second display area 302 is controlled to display the image. In this way, the user can conveniently view the real-world environment to facilitate his/her other operations while viewing the display content of the virtual scene. Thus, the display function of the head-mounted electronic device can be enhanced. Further, the first display area 301 can be controlled to display the first display content or a part thereof and the second display area 302 is controlled to display the image or a part thereof. In this way, the user can view a clear image he/she wants to view, such that the user experience can be improved.

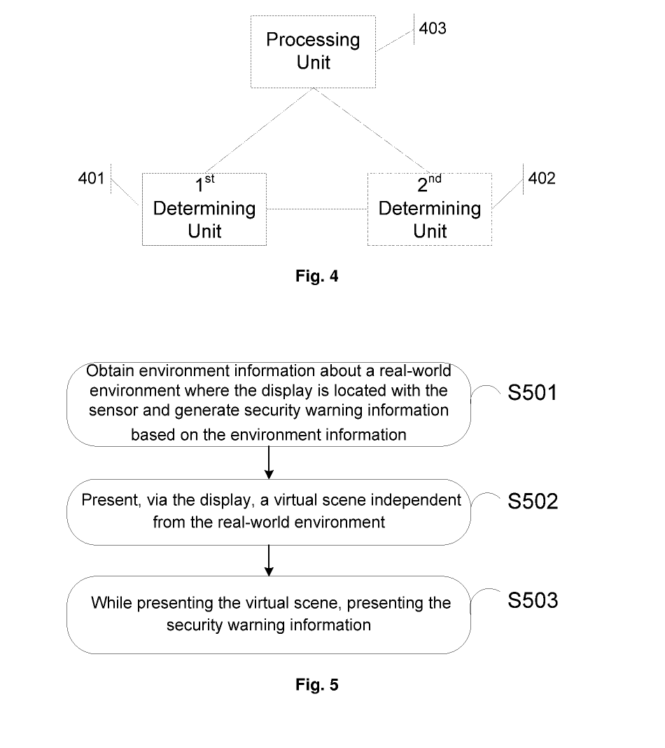

Referring to FIG. 4, based on the same inventive concept, a head-mounted electronic device is provided according to an embodiment of the present application. The head-mounted electronic device has an image capture unit and a display unit. The head-mounted electronic device further includes a first determining unit 401, and a processing unit 403.

The first determining unit 401 is configured to determine whether the head-mounted electronic device has changed from the first position to a second position.

The processing unit 403 is configured to capture an image of an environment where a user of the head-mounted electronic device is located by using the image capture unit and display the image, or a part thereof, via the display unit for viewing by the user.

Optionally, in an embodiment of the present application, the first determining unit 401 can be configured to: determine whether an angle between the head-mounted electronic device and a horizontal plane has changed from a first angle to a second angle.

Optionally, in an embodiment of the present application, the first determining unit 401 can be configured to: determine whether a distance between a gravity center of the head-mounted electronic device and a predetermined reference point has changed from a first distance to a second distance.

Optionally, in an embodiment of the present application, the first determining unit 401 can be configured to: determine whether a direction the display unit faces has changed from a first direction to a second direction.

Optionally, in an embodiment of the present application, the head-mounted electronic device may further include a second determining unit 402 configured to: determine whether a difference between the first angle and the second angle lies within a predetermined angle range.

Optionally, in an embodiment of the present application, the head-mounted electronic device may further include a second determining unit 402 configured to: determine whether a difference between the first distance and the second distance lies within a predetermined distance range.

Optionally, in an embodiment of the present application, the head-mounted electronic device may further include a second determining unit 402 configured to: determine whether an angle between the first direction and the second direction is larger than a predetermined angle threshold.

In the embodiment of the present application, in response to the user's motion, the head-mounted electronic device can automatically determine that the head-mounted electronic device has changed from the first position to the second position by utilizing one or more of the above determination schemes and set the predetermined condition depending on the user's requirement to determine whether the second position satisfies the predetermined condition, without any manual operation of the user. That is, it is possible to detect the user's operation and in turn determine the user's requirement, such that the user experience can be improved and the intelligence and applicability of the head-mounted electronic device can be enhanced.

Further, when the second position satisfies the predetermined condition, i.e., when the user's motion indicates that he/she wants to view the real-world environment, an image of the environment where the user is located can be captured by the image capture unit and the image, or a part thereof, can be displayed via the display unit. In this way, the user can view the real-world environment directly via the display unit, without having to take off or turn off the head-mounted electronic device, such that he/she can conveniently perform another operation. Thus, the operation in which the user takes off or turns off the head-mounted electronic device can be saved, such that the user can view the display content for the real-world environment while viewing the display content for the virtual scene on the display unit. In this way, the display function of the head-mounted electronic device can be improved and the market competitiveness of the head-mounted electronic device can be enhanced.

Referring to FIG. 5, an information processing method is provided according to an embodiment of the present application. The method is applied in an electronic device including a display and a sensor. The method includes the following steps.

At step S501, environment information about a real-world environment where the display is located is obtained with the sensor and security warning information is generated based on the environment information.

At step S502, a virtual scene independent from the real-world environment is presented via the virtual scene display.

At step S503, the security warning information is presented while the virtual scene is being presented.

In an embodiment, a virtual reality electronic device includes a display, such as a head-mounted 3D display, and a sensor, such as a camera, an infrared sensor, a distance sensor or the like. The display can change the virtual scene it presents in response to a sensor data obtained by the sensor, so as to make the user feel as if he/she is in the scene. In the embodiment of the present application, when the display of the electronic device is activated, the step S501 is performed to obtain the environment information and generate the security warning information based on the environment information.

In the step S501, the electronic device can obtain the environment information in any of the following ways. First, it can obtain the environment information (e.g., an image) of the real-world environment with a camera. Second, it can obtain the environment information (e.g., an infrared image) of the real-world environment with an infrared sensor. Third, it can obtain the environment information of the real-world environment with a distance sensor, including current distances from the display to various obstacles, respectively. After obtaining the environment information, the electronic device generates the security warning information based on the environment information. In particular, the electronic device can generate the security warning information by means of image analysis. For example, the user is wearing a head-mounted 3D display in a living room, ready to start an underwater adventure. When the user activates the head-mounted 3D display, the electronic device obtains an image of the living room and determines, by means of image analysis, that there is a couch 1 meter to the left of the user and a wall 3 meters in front of the user in the living room. Accordingly, the electronic device generates security warning information indicating that there is a couch 1 meter to the left of the user and a wall 3 meters in front of the user.

The security warning information generated by the electronic device may contain obstacle information and traffic condition information. In particular, the security warning information can take a form of image, text or identification symbol. When the security warning information is an image, it can be obstacle image information for identifying an obstacle in the real-world environment or image representation information for identifying a traffic condition in the real-world environment. For example, when the obstacles include a table and a wall, the security warning information may include images of the table and the wall. When the security warning information takes a form of text, it can be text information for identifying a distance between the obstacle and a landmark in the virtual scene. For example, when there is a gingko tree in the virtual scene, the security warning information can be a text message “there is a wall behind the gingko tree, please bypass it”. When the security warning information is an identification symbol, it can be identification information, i.e., traffic information, for identifying a secure area for activities in the real-world environment. For example, the secure area for activities can be indicated by arrows. Of course, the security warning information may simply include some warning messages and/or icons, e.g., “No Left Turn”, “No Touch” or “Watch Your Step”.

After generating the security warning information, the electronic device performs the step S502 for presenting the virtual scene via the display. At the same time, the electronic device performs the step S503 for presenting the security warning information while presenting the virtual scene, so as to provide the user of the electronic device with a security warning. For example, the image showing the obstacle in the real-world environment is added to the displayed virtual scene, such that the user can easily bypass the obstacle.

In practice, the virtual scene is typically very different, or even completely different, from the real-world environment. In order to avoid presenting the security warning information for a long time and affecting the scene quality of the virtual scene, in an embodiment of the present application, the process for presenting the security warning information includes the following steps. First, while the virtual scene is being presented, a current distance between the user and an obstacle associated with the obstacle information contained in the security warning information is detected. Then, it is determined whether the current distance is shorter than a predetermined distance to obtain a first determination result. Next, when the first determination result indicates that the current distance is shorter than the predetermined distance, the security warning information is displayed in the virtual scene. In particular, the predetermined distance threshold is a secure distance which can be set into a fixed value such as 20 cm, 30 cm or 50 cm or can be set in accordance with the current movement status of the user. For example, when the current movement speed of the user is 0.05 m/s, the predetermined distance is a distance the user can reach within 0.5 min, i.e., 1.5 m.

In addition, the real-world environment where the user is located may be very complicated and it is required to avoid accident in accordance with the user's actual situation. Hence, the electronic device obtains a real-world image of the real-world environment with the sensor and generates the security warning information along with the real-world image, so as to allow the user to view the real-world image as desired. Further, when the security warning information contains the real-world image of the real-world environment and the electronic device presents the virtual scene, a current distance between the user and an obstacle associated with the obstacle information contained in the security warning information is detected while the virtual scene is being presented. The real-world image is displayed instead of the virtual scene when the current distance is shorter than a predetermined distance. By displaying the real-world image, it is possible to provide the user with the actual situation in the real-world environment more comprehensively, thereby reducing the risk of accident.

While presenting the virtual scene, the electronic device automatically selects a current distance between the user and an obstacle and determines whether the current distance is shorter than a predetermined distance. Upon determining that the current distance is shorter than the predetermined distance, the electronic device displays in the virtual scene an image of the obstacle in the real-world environment or a distance between the obstacle and a landmark, thereby prompting the user to bypass the obstacle without having to switch to the real-world environment. In this way, the continuity in displaying the virtual scene can be guaranteed and the user experience can be improved.

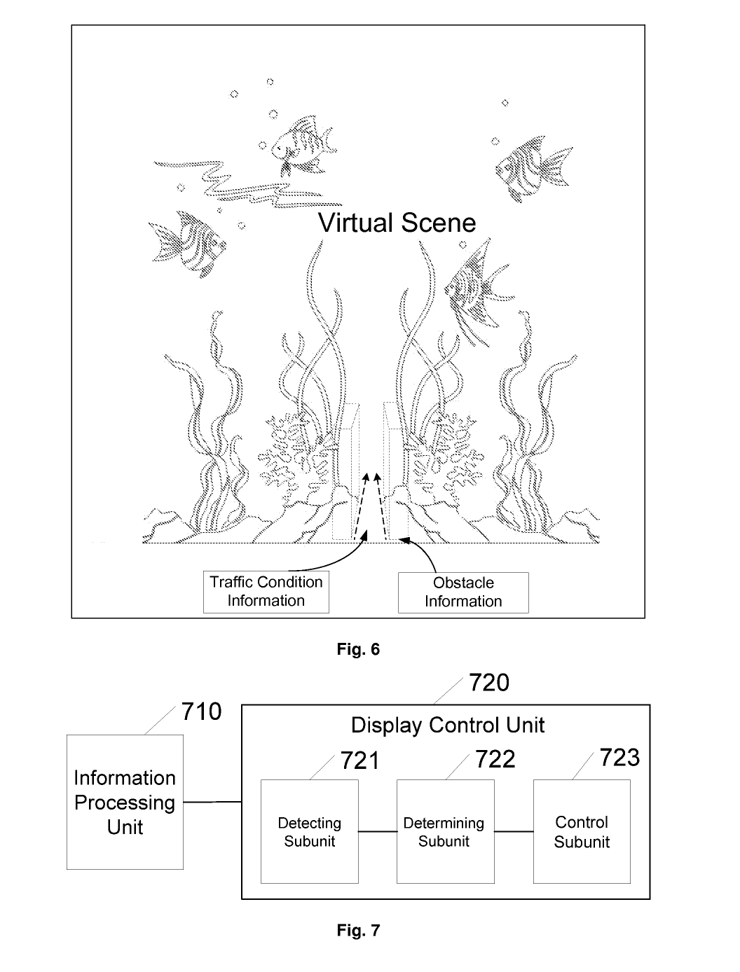

Next, referring to FIG. 6, the information processing method according to the embodiment of the present application will be described in detail in connection with a specific example. It is assumed that the sensor in the electronic device is a camera, the display is a head-mounted 3D display and the camera is provided on the head-mounted 3D display. When the user is wearing the head-mounted 3D display and activates it, the electronic device first captures environment information of the real-world environment where the display is located with the camera, i.e., a real-world image of the real-world environment where the user is located. Next, the electronic device analyzes the real-world image and obtains security warning information including obstacle information and traffic condition information. As shown in FIG. 6, the obstacle information is an image of an obstacle and the traffic condition information is a secure area of activities indicated by arrows. Then, the electronic device presents a virtual scene, e.g., a virtual underwater world, via the head-mounted 3D display. While displaying the virtual scene via the head-mounted 3D display, the electronic device presents the image of the obstacle and the secure area of activities indicated by arrows.

In the above embodiment, the electronic device obtains the environment information of the real-world environment where the display is located, and generates the security warning information based on the environment information, so as to presenting the security warning information associated with the real-world environment while presenting the virtual scene, thereby providing the user with the security warning. In this way, it is possible to avoid the security problem when the user is using the display and thus cannot view the real-world environment, so as to solve the technical problem in the prior art associated with low security in use of the display and improve the security in use of the display.

Referring to FIG. 7, according to an embodiment of the present application, an electronic device is provided. The electronic device includes a display and a sensor. The electronic device further includes the following units.

An information processing unit 710 is configured to obtain environment information about a real-world environment where the display is located with the sensor and generate security warning information based on the environment information.

The display control unit 720 is configured to present, via the display, a virtual scene independent from the real-world environment along with the security warning information.

In an embodiment, the security warning information contains obstacle information and traffic condition information.

In an embodiment, the display control unit 720 includes: a detecting subunit 721 configured to detect, while presenting the virtual scene, a current distance between the user and an obstacle associated with the obstacle information contained in the security warning information; a determining subunit 722 configured to determine whether the current distance is shorter than a predetermined distance; and a control subunit 723 configured to display the security warning information in the virtual scene if the current distance is shorter than the predetermined distance.

In an embodiment, when the security warning information includes a real-world image of the real-world environment, the display control unit 720 includes: a detecting subunit 721 configured to detect, while presenting the virtual scene, a current distance between the user and an obstacle associated with the obstacle information contained in the security warning information; and a control subunit 723 configured to display an image of the real-world environment instead of the virtual scene if the current distance is shorter than a predetermined distance.

In an embodiment, the security warning information includes at least one of: obstacle image information for identifying an obstacle in the real-world environment that is associated with the obstacle information; text information for identifying a distance between the obstacle and a landmark in the virtual scene; image representation information for identifying a traffic condition in the real-world environment; and identification information for identifying a secure area for activities in the real-world environment.

The above embodiments of the present application have the following technical effects. The electronic device obtains the environment information of the real-world environment where the display is located, and generates the security warning information based on the environment information, so as to presenting the security warning information associated with the real-world environment while presenting the virtual scene, thereby providing the user with the security warning. In this way, it is possible to improve the security in use of the display. While presenting the virtual scene, the electronic device automatically selects a current distance between the user and an obstacle and determines whether the current distance is shorter than a predetermined distance. Upon determining that the current distance is shorter than the predetermined distance, the electronic device displays in the virtual scene an image of the obstacle in the real-world environment or a distance between the obstacle and a landmark, thereby prompting the user to bypass the obstacle without having to switch to the real-world environment. In this way, the continuity in displaying the virtual scene can be guaranteed and the user experience can be improved.

It can be appreciated by those skilled in the art that the above embodiment has been described with reference to an example in which it is divided into individual functional modules. In practice, the above functions can be assigned to different functional modules as desired. That is, the internal structure of the apparatus can be divided into different functional modules for achieving part or all of the above described functions. For details of the operations of the above described system, apparatus and units, reference can be made to the embodiment of the method and the description thereof will be omitted here.

It can be appreciated from the embodiments of the present application that the disclosed system, apparatus and method can be implemented in alternative ways. The device embodiments as described above are illustrative only. For example, while the units have been divided in accordance with their logical functions, other divisions are possible in practice. For example, more than one unit or element can be combined or can be integrated into another system, or some features can be ignored or omitted. In addition, the coupling, direct coupling or communicative connection between various components as shown or discussed can be an indirect coupling or communicative connection via some interface, device or unit and can be electrical, mechanical or in another form.

The units described above as separated may or may not be physically separated. The components shown as units may or may not be physical units. They can be co-located or can be distributed over a number of network elements. Depending on actual requirements, some or all of the units can be selected to achieve the object of the present application.

Further, all the functional units in various embodiments of the present application can be integrated within one processing unit, or each of these units can be a separate unit, or two or more units can be integrated into one unit. Such integrated unit can be implemented in hardware, possibly in combination with software functional units.

The integrated units of the present application as described above can be implemented as software functional modules and sold or used as standalone produces. In this case, they can be stored in a computer readable storage medium. In view of this, the technical solutions according to the embodiments of the present application, or in other words a part thereof which makes contribution over the prior art, can be substantially embodied in a form of software product. The computer software product can be stored in a storage medium containing instructions which cause a computer device (which can be a personal computer, a server, a network device or the like) or a processor to perform one or more methods according to the embodiments of the present application or particular parts thereof. The storage medium may be any of various mediums capable of storing program codes, such as a USB disk, a hard disk, a Read Only Memory (ROM), a Random Access Memory (RAM), a magnetic disk or an optical disc.

While the embodiments of the present application have been described above, the scope of the present application is not limited thereto. Various modifications and alternatives can be made by those skilled in the art without departing from the scope of the present disclosure. These modifications and alternatives are to be encompassed by the scope of the present application which is only defined by the claims as attached.

What is claimed is:

1. An information processing method, comprising:
determining whether a head-mounted electronic device has changed from a first position to a second position, wherein the head-mounted electronic device comprises an image capture unit and a display unit for displaying a virtual scene; and
capturing an image of an environment where a user of the head-mounted electronic device is located by using the image capture unit of the head-mounted electronic device and displaying the image, or a part thereof, via the display unit of the head-mounted electronic device for viewing by the user.

2. The method of claim 1, wherein said determining whether the head-mounted electronic device has changed from the first position to the second position comprises:
determining whether an angle between the head-mounted electronic device and a horizontal plane has changed from a first angle to a second angle.

3. The method of claim 2, further comprising determining whether the second position satisfies a predetermined condition, which comprises:
determining whether a difference between the first angle and the second angle lies within a predetermined angle range.

4. The method of claim 1, wherein said determining whether the head-mounted electronic device has changed from the first position to the second position comprises:
determining whether a distance between a gravity center of the head-mounted electronic device and a predetermined reference point has changed from a first distance to a second distance.

5. The method of claim 4, further comprising determining whether the second position satisfies a predetermined condition, which comprises:
determining whether a difference between the first distance and the second distance lies within a predetermined distance range.

6. The method of claim 1, wherein said determining whether the head-mounted electronic device has changed from the first position to the second position comprises:
determining whether a direction the display unit faces has changed from a first direction to a second direction.

7. The method of claim 6, further comprising determining whether the second position satisfies the predetermined condition, which comprises:
determining whether an angle between the first direction and the second direction is larger than a predetermined angle threshold.

8. A head-mounted electronic device, comprising:
an image capture unit;
a display unit for displaying a virtual scene:
a first determining unit configured to determine whether the head-mounted electronic device has changed from a first position to a second position; and
a processing unit configured to capture an image of an environment where a user of the head-mounted electronic device is located by using the image capture unit and display the image, or a part thereof, via the display unit for viewing by the user.

9. The electronic device of claim 8, wherein the first determining unit is configured to:
determine whether an angle between the head-mounted electronic device and a horizontal plane has changed from a first angle to a second angle.

10. The electronic device of claim 9, further comprising a second determining unit configured to:
determine whether a difference between the first angle and the second angle lies within a predetermined angle range.

11. The electronic device of claim 8, wherein the first determining unit is configured to:
determine whether a distance between a gravity center of the head-mounted electronic device and a predetermined reference point has changed from a first distance to a second distance.

12. The electronic device of claim 11, further comprising a second determining unit configured to:
determine whether a difference between the first distance and the second distance lies within a predetermined distance range.

13. The electronic device of claim 8, wherein the first determining unit is configured to:
determine whether a direction the display unit faces has changed from a first direction to a second direction.

14. The electronic device of claim 13, further comprising a second determining unit configured to:
determine whether an angle between the first direction and the second direction is larger than a predetermined angle threshold.

15. An electronic device comprising:
a display;
a sensor;
an information processing unit configured to obtain environment information about a real-world environment where the display is located by using the sensor and generate security warning information based on the environment information; and
a display control unit configured to present, via the display, a virtual scene independent from the real-world environment along with the security warning information.

16. The electronic device of claim 15, wherein the security warning information contains obstacle information and traffic condition information.

17. The electronic device of claim 16, wherein the display control unit further comprises:
a detecting subunit configured to detect, while presenting the virtual scene, a current distance between the user and an obstacle associated with the obstacle information contained in the security warning information;
a determining subunit configured to determine whether the current distance is shorter than a predetermined distance; and
a control subunit configured to display the security warning information in the virtual scene if the current distance is shorter than the predetermined distance.

18. The electronic device of claim 16, wherein the display control unit further comprises:
a detecting subunit configured to detect, while presenting the virtual scene, a current distance between the user and an obstacle associated with the obstacle information contained in the security warning information; and
a control subunit configured to display an image of the real-world environment instead of the virtual scene, if the current distance is shorter than a predetermined distance.

19. The electronic device of claim 15, wherein the security warning information comprises at least one of:
obstacle image information for identifying an obstacle in the real-world environment that is associated with the obstacle information;
text information for identifying a distance between the obstacle and a landmark in the virtual scene;
image representation information for identifying a traffic condition in the real-world environment; and
identification information for identifying a secure area for activities in the real-world environment.
